(19) United States
(12) Patent Application Publication
(10) Pub. No.: US 2009/0295909 A1
(43) Pub. Date: Dec. 3, 2009

(54) Device and Method for 2D-3D Switchable Autostereoscopic Viewing

(76) Inventor: Xavier Levecq, Gif sur Yvette (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/988,337

(22) PCT Filed: Jul. 3, 2006
(86) PCT No.: PCT/FR2006/001565

§ 371 Date: Apr. 30, 2008

(30) Foreign Application Priority Data
Jul. 4, 2005 (FR) 0507100

(51) Int. Cl. H04N 13/04; G02B 27/22

(52) U.S. Cl. 348/59; 359/463; 348/E13.075

(57) ABSTRACT

An autostereoscopic viewing device switchable between a two-dimensional mode and a three-dimensional mode. The device generally includes a matrix viewing display, and a set of two lenticular networks or arrays, one of which is called a converting lenticular network or array. The lenticular networks or arrays are arranged in front of the viewing display. The converting lenticular array is designed to receive and optically process a raster or matrix image emitted by the viewing display. The autostereoscopic viewing device further includes means for varying a plurality of distances between a first lenticular array and a second lenticular array or the viewing display. The invention is useful in particular for computer displays or three-dimensional television sets.

### TECHNICAL FIELD

This invention relates to an autostereoscopic display device that can be switched between two display modes: a conventional 2D mode in which a viewer perceives the screen as a two-dimensional image, and a 3D mode in which the two eyes of the viewer receive different information coming from the autostereoscopic screen, thus giving the viewer the impression of volume. It also relates to a method for a display that can be switched between a 2D display mode and a 3D display mode, implemented in this device.

The present invention therefore relates to three-dimensional color displayed images or computer or television screens, intended for example to broadcast advertisements or information to the public or to display informational or entertainment content.

### PRIOR ART

It is currently known how to produce devices for autostereoscopic display without glasses. These devices are composed, on the one hand, of a two-dimensional screen based, for example, on liquid crystal or plasma technology, and, on the other hand, a 2D-3D conversion screen arranged at a small distance from the two-dimensional screen. This conversion screen can, for example, consist either of a parallax barrier composed of an alternation of opaque and transparent fine bands, or of a lenticular network including a layer of semi-cylindrical lenses parallel to one another.

The conversion screen enables an angular selection of pixels of the two-dimensional screen, which makes it possible to send different information to the left eye and to the right eye of a viewer of an autostereoscopic display device, giving the viewer an impression of volume if the successive pixels of the two-dimensional display screen encode shots of the same scene, slightly angularly offset. The number of different shots encoded on the two-dimensional screen is dependent on geometric and physical properties of the components of the autostereoscopic display device.

However, such an autostereoscopic device has a disadvantage. The spectator has an impression of volume, even though in reality the object observed is an image without depth. Thus, the muscles of the viewer's eyes do not move to observe different focal planes, even if the viewer's brain has the opposite impression. This can thus be a source of fatigue and headaches.

It would therefore be beneficial to propose an autostereoscopic display device capable of switching between two display modes: a 2D display mode and a 3D display mode.

Such a device is described in the patent application EP 1401216 A2 entitled “Autostereoscopic display”. To switch from 3D mode to 2D mode, the inventor proposes removing the parallax barrier from the autostereoscopic display device, thus obtaining two separate objects: a two-dimensional display device, and an unused parallax barrier.

Such a device is also described in the patent application U.S. Pat. No. 5,500,765 A entitled “Convertible 2D/3D autostereoscopic display”. In this case, the conversion screen of the autostereoscopic device is a lenticular network. To switch from the 3D display mode to the 2D display mode, it is proposed to place, on the conversion screen, a second lenticular screen compensating for the effect of the conversion screen, which second lenticular screen is initially kept away by a hinge system, for example. Thus, according to this device:
in the 3D display mode, the images transmitted by the display screen of the autostereoscopic display device pass only through the conversion screen before reaching the viewer's eyes, while the second lenticular screen is kept away;
in the 2D display mode, the second lenticular screen is placed on the conversion screen.

The two devices described above are not compact, in the sense that to switch between the 2D and 3D display modes, the user must remove or add a screen.

The objective of this invention is to propose a compact autostereoscopic display device capable of switching between two display modes: a 2D display mode and a 3D display mode.

### DESCRIPTION OF THE INVENTION

This objective is achieved with an autostereoscopic display device that can be switched between a two-dimensional display mode and a three-dimensional display mode, including a matrix display screen, a set of lenticular networks including at least one so-called lenticular conversion network, in which the lenticular networks are placed in front of said display screen, with said lenticular network being arranged to receive and optically process a matrix image transmitted by said display screen,

characterized in that it also includes means for varying a plurality of distances between a first lenticular network and a second lenticular network or the display screen.

In a first embodiment, the set of lenticular networks may include only a so-called lenticular conversion network.

In a second embodiment, the set of lenticular networks can include a so-called lenticular conversion network in front of said display screen, and a second so-called lenticular switching network placed between the display screen and the lenticular conversion network, with the lenticules of the lenticular switching and conversion networks being aligned face-to-face. The covering power C4 of the lenticules of the lenticular switching network can have an opposite sign, but with the same absolute value as the covering power C3 of the lenticules of the lenticular conversion network (C3=−C4).

The lenticular networks can have a lenticular axis tilted according to the same angle alpha ≧0 with respect to a vertical axis of the display screen.

The display screen can include an electronic plasma screen, an electronic liquid crystal (LCD) screen, or a screen based on any other matrix technology.

The means for varying distances can include a piezoelectric motor, an electric motor, or screw- or pushbutton-type mechanical movement means.

According to another aspect of the invention, an autostereoscopic display method is proposed, which is implemented in a device according to the invention, including the steps of:
encoding a matrix image integrating P shots of the same scene on a matrix display screen,
receiving and optically processing a matrix image by a set of lenticular networks, and
switching between a two-dimensional display mode and a three-dimensional display mode, including a change in the matrix image encoding on the display screen between a two-dimensional mode and a three-dimensional mode,

characterized in that the switching between the display modes also includes a variation of a plurality of distances between a first lenticular network and a second lenticular network or a display screen.

In a first embodiment, this method can be implemented for an autostereoscopic display device in which a set of lenticular networks includes only one so-called lenticular conversion network arranged so as to receive and optically process a matrix image transmitted by said display screen. In this first mode, the switching between a two-dimensional display mode and a three-dimensional display mode can consist:
of switching to a two-dimensional display mode including the movement of the lenticular conversion network to a display screen distance substantially equal to twice the focal distance of the lenticules of the lenticular conversion network, or
switching to a two-dimensional display mode including the movement of the lenticular conversion network to a display screen distance substantially equal to zero, or
switching to a three-dimensional display mode including the movement of the lenticular conversion network to a display screen distance substantially equal to the focal distance of the lenticules of the lenticular conversion network.

In a second embodiment, this method can be implemented for an autostereoscopic display device in which the set of lenticular networks includes a so-called lenticular conversion network placed in front of said display screen, and a second so-called lenticular switching network arranged between the display screen and the lenticular conversion network, with the lenticules of the lenticular switching and conversion networks being aligned face-to-face. In this second mode, the switching between a two-dimensional display mode and a three-dimensional display mode can consist:
of switching to a two-dimensional display mode including the movement of at least one lenticular network so that, in the same optical space, a focal plane of the lenticular conversion network is substantially merged with a focal plane of the lenticular switching network, or
switching to a three-dimensional display mode including the movement of at least one lenticular network so that a focal plane formed by an optical system including the lenticular conversion and switching networks is substantially merged with the display screen.

In a particular case of this second embodiment, the covering power C4 of the lenticules of the lenticular switching network can have the opposite sign, but the same absolute value as the covering power of the lenticules of the lenticular conversion network (C3=−C4). In this particular case, the switching between a two-dimensional display mode and a three-dimensional display mode can consist of a switch to a two-dimensional display mode including the movement of at least one lenticular network, so that the lenticular conversion network (3) is at a distance from the lenticular switching network (4) substantially equal to zero. Also in this particular case, the switching between a two-dimensional display mode and a three-dimensional display mode can consist of a switch to a three-dimensional display mode including the movement of at least one lenticular network, so that:
the lenticular conversion network (3) is at a distance from the display screen (2) substantially equal to the focal distance of the lenticules of the lenticular conversion network, and
the lenticular conversion network (3) is at a distance from the lenticular switching network (4) substantially equal to the focal distance of the lenticules of the lenticular conversion network.

### DESCRIPTION OF THE FIGURES AND EMBODIMENT

Other advantages and features of the invention will appear on examining the detailed description of an embodiment that is in no way limiting, and the appended drawings, in which:

FIG. 1 is a general view of an autostereoscopic display device according to the invention,

FIG. 2 shows a 3D display mode of an autostereoscopic display device according to the prior art including a lenticular network,

FIG. 3 shows a 2D display mode, with a magnification equal to −1, of an autostereoscopic display device according to the invention including a lenticular network,

FIG. 4 shows a 2D display mode, with a magnification of 1, of an autostereoscopic display device according to the invention including a lenticular network,

FIG. 5 shows a 3D display mode of an autostereoscopic display device according to the invention including two lenticular networks, and

FIG. 6 shows a 2D display mode of an autostereoscopic display device according to the prior art including two lenticular networks.

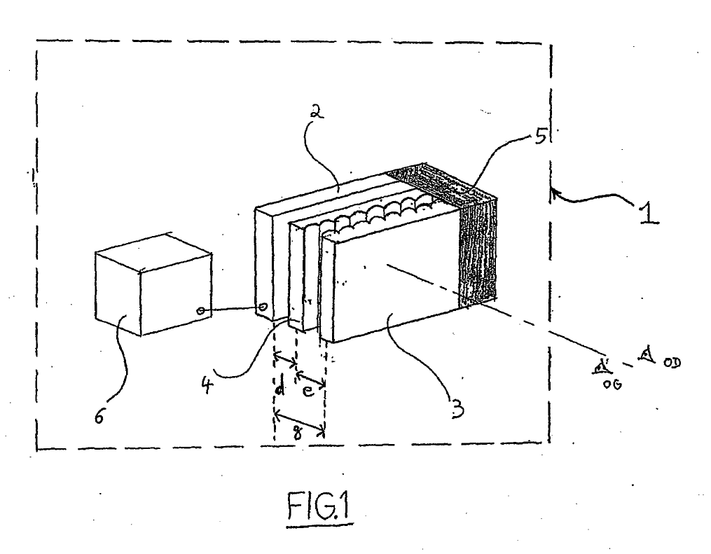

We will first describe, in reference to FIG. 1, an example of an autostereoscopic display device according to the invention.

The autostereoscopic display device 1 includes a matrix display screen 2, and a set of lenticular networks. This set includes at least one first so-called lenticular conversion network 3 placed at a distance g in front of said display screen 2.

The lenticular conversion network 3 is arranged to receive and optically process a matrix image transmitted by the display screen 2, which matrix image is encoded so as to integrate a plurality P of viewpoints of the same scene, which display screen 2 includes a matrix of screen pixels each including three color cells. In three-dimensional mode, the left eye LE and the right eye RE of a viewer of the autostereoscopic display device receive different information, thus giving the viewer an impression of volume. The focal distance of the lenticules of the lenticular conversion network is denoted as f.

The display device 1 includes means 5 for varying a plurality of distances between a first lenticular network and a second lenticular network or display screen. Thus, the lenticular networks and the display screen can be moved with respect to the others, alone or in groups, which makes it possible to switch between different display modes.

The display screen 2 is connected to an electronic module 6 for generating encoded images.

The set of networks can also include a second so-called lenticular switching network 4 arranged between the display screen 2 and the lenticular conversion network 3. If this set includes a lenticular switching network, the lenticules of the lenticular switching 4 and conversion 3 networks are aligned face-to-face, the lenticules of the lenticular switching network 4 have a covering power C4, and the lenticules of the lenticular conversion network 3 have a covering power C3. As the distance between the lenticular switching network 4 and the lenticular conversion network 3 is denoted as e, the overall covering power CG of the system formed by the lenticular switching 4 and conversion 3 networks can then vary according to the distance e. The distance between the display screen 2 and the lenticular switching network 4 is denoted as d.

This lenticular switching network 4 has a plurality of operating positions, which makes it possible to switch the autostereoscopic display device 1 between 2D and 3D display modes.

FIG. 2 shows a 3D display mode of an autostereoscopic display device including a single lenticular network. This figure shows a display screen 2 and a lenticular conversion network 3 spaced apart by a distance g substantially equal to the focal distance f of the lenticules of the lenticular conversion network. In this mode, the lenticular conversion network 3 angularly selects pixels of the two-dimensional screen, which makes it possible to send different information to the left eye and to the right eye of a viewer of the autostereoscopic display device, thus giving the viewer the impression of volume.

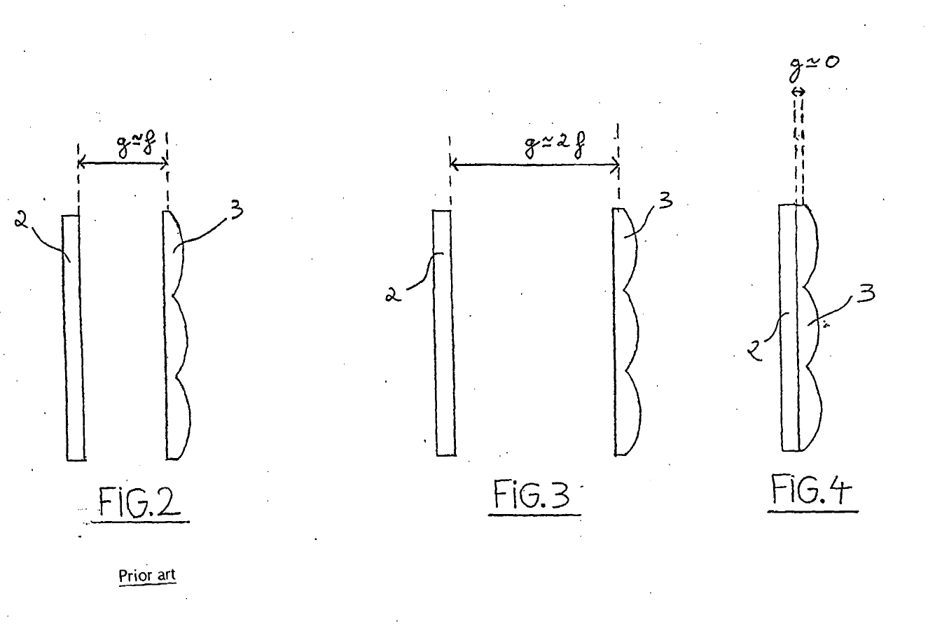

FIG. 3 shows a 2D display mode, with a magnification equal to −1, of an autostereoscopic display device according to the invention including a single lenticular network. This figure shows a display screen 2 and a lenticular conversion network 3 spaced apart by a distance g substantially equal to twice the focal distance f of the lenticules of the lenticular conversion network. In this case, an image must be encoded in the wrong-reading frame on the display screen, at the scale of a lenticule, if this image is to be seen in the right-reading frame.

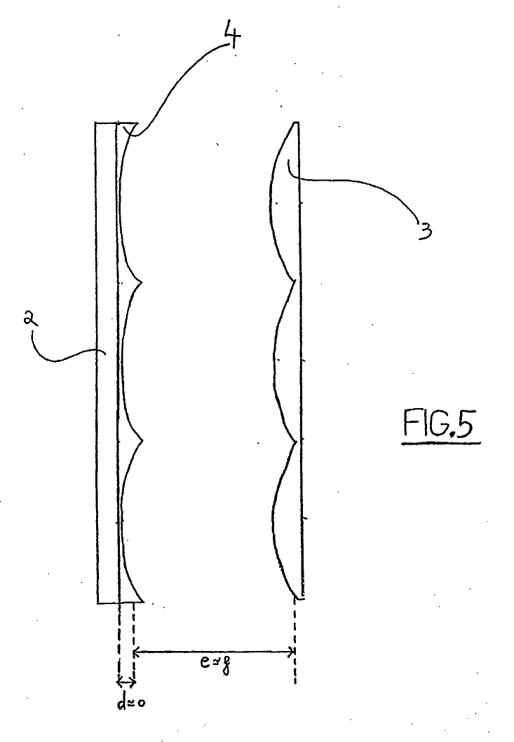

FIG. 4 shows a 2D display mode, with a magnification of 1, of an autostereoscopic display device according to the invention including a single lenticular network. This figure shows a display screen 2 and a lenticular conversion network 3 spaced apart by a distance g substantially equal to zero.

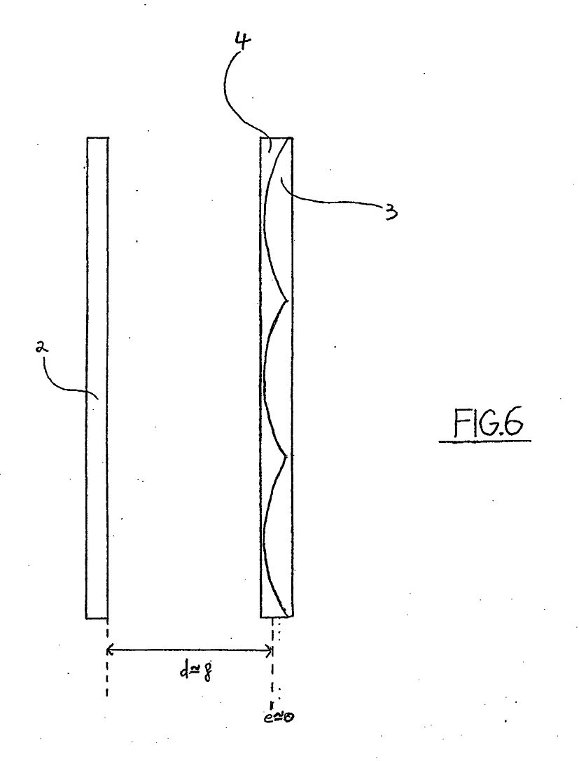

FIG. 5 shows a 3D display mode of an autostereoscopic display device according to the invention including two lenticular networks, called conversion 3 and switching 4 networks, and a display screen 2, as in FIG. 1. We will consider the particular case in which the covering power C4 of the lenticules of the lenticular switching network 4 is opposite the covering power C3 of the lenticules of the lenticular conversion network 3: C4=−C3. In this figure, the position of the lenticular switching network is such that e≈f and d≈0. In this position, the lenticular switching network 4 is on the focal plane of the lenticular conversion network 3, and its effect is therefore zero. The display screen is also on the focal plane of the conversion network 3, which receives and optically processes the matrix images transmitted by the display screen 2. When the switching network is pressed against the display screen, the distance e has a value almost equal to f the focal distance of the lenticules of the lenticular conversion network, and the overall covering power CG of the system formed by the lenticular networks is equal to C3:

CG=C3+C4−e*C3*C4=C3+C4−f*C3*C4=C3 because 1/f−C3.

The autostereoscopic display device 1 is then in 3D display mode.

This example shows a particular case in which the focal object plane formed by the optical system including the lenticular conversion and switching networks is substantially merged with the display screen.

FIG. 6 shows a 2D display mode of an autostereoscopic display device according to the invention including two lenticular networks, called conversion 3 and switching 4 networks, and a display screen 2, as in FIG. 1. We will consider the particular case in which the covering power C4 of the lenticules of the lenticular switching network 4 is opposite the covering power C3 of the lenticules of the lenticular conversion network 3: C4=−C3. In this figure, the position of the lenticular switching network 4 is such that e≈0 and d≈f. In reality, it is only important that the two lenticular networks be joined together, while the position of the pair of lenticular networks with respect to the display screen is of little importance. In this position, the lenticular switching network 4 is pressed against the lenticular conversion network 3 with an opposite covering power, and their effects cancel one another out. The display device is then diagrammatically composed of a display screen in front of which is a plate with two parallel faces. When the switching network is pressed on the conversion network, e is zero and the overall covering power CG of the system formed by the lenticular networks is equal to 0:

CG=C3+C4−e*C3*C4=0 because e=0 and C3=−C4

The autostereoscopic display device 1 is then in 2D display mode.

This example shows a particular case in which the focal object plane of the lenticular conversion network is substantially merged with the focal image plane of the lenticular switching network.

In a practical embodiment:
the display screen is a PIONEER plasma screen of reference PDP50MXE1, of which each pixel is composed of three colored cells of red, green and blue, which cells are aligned horizontally, and each cell having a width of 286 μm and a height of 808 μm,
the lenticular conversion network is a network of convex semi-cylindrical lenses parallel to one another as well as to the vertical axis of the plasma screen. This lenticular network is placed in front of the plasma screen at a distance substantially equal to the focal length f=9 mm of the lenticules, i.e. semi-cylindrical lenses,
the lenticular switching network is a network of concave semi-cylindrical lenses parallel to one another as well as to the vertical axis of the plasma screen. The focal distance of its lenticules is opposite the focal distance of the lenticules of the conversion network,
the means for varying a plurality of distances between a first lenticular network and a second lenticular network or the display screen are provided with an electric motor and a mechanical device for converting a rotary movement into a linear movement.

Of course, the invention is not limited to the examples described above, and numerous modifications can be made to these examples without going beyond the scope of the invention. In particular, the invention can be implemented with other types of matrix structure or other means for varying a plurality of distances between a first lenticular network and a second lenticular network or a display screen.

1. An autostereoscopic display device that can be switched between a two-dimensional display mode and a three-dimensional display mode, comprising:
a matrix display screen;
a set of lenticular networks including at least one lenticular conversion network, wherein the at least one lenticular networks are placed in front of said display screen, and wherein the at least one lenticular conversion network is arranged to receive and optically process a matrix image transmitted by said display screen; and
means for varying a plurality of distances between on a first lenticular network and a second lenticular network or the display screen,
wherein the set of lenticular networks comprises one of either:
a single lenticular conversion network wherein the means for varying is adapted to vary at least a distance between the single lenticular conversion network and the display screen between one and two times a focal distance of the lenticular conversion network, or
a lenticular conversion network placed in front of said display screen and a second lenticular switching network placed between the display screen and the lenticular conversion network with lenticules of the lenticular switching network and the lenticular convesion network being aligned face-to-face, wherein the means for varying is adapted to vary a distance between the lenticular conversion network and the lenticular switching network.

2-3. (canceled)

4. The autostereoscopic device according to claim 1, wherein a covering power of the lenticules of the lenticular switching network has the opposite sign but the same absolute value as a covering power of the lenticules of the lenticular conversion network, and the distance between the lenticular conversion network and the lenticular switching network is varied between zero and one time a focal distance of the lenticular networks.

5. The autostereoscopic device according to claim 1, wherein the at least one lenticular networks has a lenticular axis tilted according to the same angle alpha ≧0 with respect to a vertical axis of the display screen.

6. The autostereoscopic device according to claim 1, wherein the display screen comprises an electronic plasma screen.

7. The autosteroscopic device according to claim 1, wherein the display screen comprises an electronic liquid crystal (LCD) screen.

8. The autostereoscopic device according to claim 1, wherein the means for varying distances comprises a piezoelectric motor.

9. The autostereoscopic device according to claim 1, wherein the means for varying distances comprises an electric motor.

10. The autostereoscopic device according to claim 1, wherein the means for varying distances include screw- or pushbutton-type mechanical movement means.

11. A method for autostereoscopic display comprising:
encoding a matrix image integrating P shots of a same scene on a matrix display screen:
receiving and optically processing the matrix image by a set of lenticular networks wherein the set of lenticular networks comprises one of either:
a first set comprising a single lenticular conversion network, or
a second set comprising a lenticular conversion network placed in front of said display screen and a second lenticular switching network placed between the display screen and the lenticular conversion network with lenticules of the lenticular switching network and the lenticular convesion network being aligned face-to-face; and
switching between a two-dimensional display mode and a three-dimensional display mode, wherein the switching comprises a change in the matrix image encoding on the display screen between a two-dimensional mode and a three-dimensional mode, and a variation of at least one of a first distance between lenticular conversion network and the display screen when the set of lenticular networks comprises the first set, and a second distance between the lenticular conversion network and a lenticular switching network when the set of lenticular networks comprises the second set, wherein the first distance is varied between one and two times a focal distance of the lenticular conversion network.

12-15. (canceled)

16. The method according to claim 15, wherein the switching between a two-dimensional display mode and a three-dimensional display mode comprises switching to a two-dimensional display mode including a movement of at least one lenticular network when the set of lenticular networks comprises the second set, so that, in a same optical space, a focal plane of the lenticular conversion network is substantially merged with a focal plane of the lenticular switching network.

17. The method according to claim 16, wherein the switching between a two-dimensional display mode and a three-dimensional display mode consists of switching to a three-dimensional display mode including a movement of at least one lenticular network when the set of lenticular networks comprises the second set, so that a focal plane formed by an optical system including the lenticular conversion and switching networks is substantially merged with the display screen.

18-20. (canceled)
